(19) United States
(12) Patent Application Publication
(10) Pub. No.: US 2026/0244462 A1
(43) Pub. Date: Aug. 20, 2026

(54) AUTOMATIC ANNOTATIONS AND DESIGN FLOW ANALYZER

(71) Applicant: Evinced, Inc., Los Altos Hills, CA (US)

(72) Inventors: Yossi SYNETT, Hod Hasharon (IL); Gal MOAV, Tel Aviv (IL); Navin R. THADANI, Los Altos Hills, CA (US); Tal KAILLER, Tel Aviv (IL); Tair HAKMAN, Katzrin (IL); Anastasiia VOIEVIDKA, Krakow (PL); Gilad GIMMON, Ramat Gan (IL); Oren SHLOMI, Rehovot (IL); Jan ROGALO, Gdansk (PL)

(73) Assignee: Evinced, Inc., Los Altos Hills, CA (US)

(21) Appl. No.: 19/436,820

(22) Filed: Dec. 30, 2025

Related U.S. Application Data
(60) Provisional application No. 63/760,869, filed on Feb. 20, 2025.

(51) Int. Cl. G06F 9/451; G06T 11/60

(52) U.S. Cl. CPC G06F 9/451; G06T 11/60; G06T 2200/24

(57) ABSTRACT

The system and method for improving navigability of digital interfaces for accessibility technology users is presented. The method includes receiving a prototype of a design of a digital interface and underlying data structures, wherein a prototype is an interactive, visual representation of plurality of layouts of a digital interface that simulates a user experience of navigating between the layouts; annotating each graphical user interface (GUI) element of the prototype with a label that provides sufficient detail to identify the purpose of the GUI element; verifying that a user flow is executable on the prototype, wherein a user flow is a navigation path by an accessibility technology user through the layouts of the prototype; generating a score for the prototype based on a level of accessibility of the prototype for the user flow; and implementing improvements in the prototype, wherein implementing improvements serve to increase the score for the user flow.

### CROSS-REFERENCE TO RELATED APPLICATIONS

This application claims the benefit of US Provisional Application No. 63/760,869 filed on February 20, 2025, the contents of which are hereby incorporated by reference.

### BACKGROUND

Digital interfaces must be accessibility compliant. The Web Content Accessibility Guidelines (WCAG) provide guidelines and standards to determine when a digital interface is accessible to users with a variety of disabilities. These guidelines require developers to ensure that content is navigable and usable by users with a variety of disabilities including, but not limited to, those without sight or with visual impairment. Ensuring such navigability and usability includes, but is not limited to, ensuring that all images have descriptive alternative text and ensuring compatibility with screen readers. The WCAG guidelines are built around four core principles: perceivable, operable, understandable, and robust.

The perceivable principle ensures that information and user interface components are presented in ways that users can perceive. Key guidelines (from WCAG) include “1.1.1 Non-text Content,” which requires providing text alternatives for non-text content like images and icons so that they can be accessed by screen readers; “1.3.1 Info and Relationships,” which ensures that information that is conveyed visually is also conveyed programmatically, using semantic HTML and ARIA roles for screen readers; “1.3.2 Meaningful Sequence,” which ensures content is in the correct reading order; “1.3.3 Sensory Characteristics,” which ensures content is not solely dependent on sensory characteristics, such as color or shape, to convey meaning; “1.3.5 Identify Input Purpose,” which requires input fields to be programmatically identified by screen readers; and “1.3.6 Identify Purpose,” which ensures UI components are clearly labeled so assistive technologies can determine their purpose.

The operable principle ensures that users can interact with the content and interface. Key guidelines (from WCAG) include “2.1.1 Keyboard,” which mandates that all functionality must be operable via a keyboard; “2.1.2 No Keyboard Trap,” which ensures that users cannot get stuck in an interface element when using a keyboard; “2.4.1 Bypass Blocks,” which offers skip links for screen reader users to skip repetitive content; “2.4.2 Page Titled,” which ensures each page has a meaningful title that aids navigation; “2.4.3 Focus Order,” which ensures that the navigation order is logical, helping users using screen readers; “2.4.4 Link Purpose (In Context),” which ensures that links have clear, descriptive text; “2.4.6 Headings and Labels,” which requires clear headings and labels for better understanding; and “2.4.8 Location,” which provides navigation indicators to assist screen reader users.

The understandable principle ensures that content and interactions are clear and predictable. Key guidelines include, “3.2.1 On Focus,” which ensures that receiving focus does not trigger unexpected changes, preventing confusion for users; “3.2.2 On Input,” which prevents automatic changes when a user inputs data into a form, reducing errors; “3.2.3 Consistent Navigation,” which ensures that navigation mechanisms are consistent across the site; “3.2.4 Consistent Identification,” which ensures that components with the same function have consistent labels; “3.3.1 Error Identification,” which ensures that errors in forms are identifiable for screen readers; “3.3.2 Labels or Instructions,” which ensures forms include proper labels for assistive technologies; “3.3.3 Error Suggestion,” which provides suggestions for correcting errors in forms; and “3.3.4 Error Prevention” prevents major errors by confirming submission actions.

The robust principle focuses on creating content that can be reliably interpreted by a wide variety of assistive technologies. Key guidelines (from WCAG) include “4.1.2 Name, Role, Value,” which ensures that UI components expose their name, role, and value to assistive technologies, providing the necessary context for users; and “4.1.3 Status Messages,” which ensures that dynamic content updates are announced by screen readers, allowing users to stay informed of changes in the content without needing to manually refresh the page.

For digital interfaces to be compliant with accessibility standards, designers and developers must create code that supports features like semantic HTML, proper heading structures, keyboard navigability, and ARIA (Accessible Rich Internet Applications) roles and attributes. ARIA roles and attributes help to improve the accessibility of dynamic content or complex user interfaces, providing additional information to assistive technologies about the behavior and purpose of elements.

However, there are several challenges with designing digital interfaces to be accessible. First, designers often overlook crucial aspects of accessibility when planning user interfaces, such as properly incorporating landmarks, headings, and ensuring correct focus and reading orders. As a result, many interfaces fail to be fully accessible to screen reader users, as elements may not be properly labeled or organized in a way that makes navigation efficient for those relying on assistive technologies. For example, elements of a design of a digital interface are often not given meaningful names (e.g., a button called “rectangle8”), which makes it difficult to automatically identify those elements for accessibility purposes. Moreover, there is a common issue with the handover process between designers and developers. Designers may provide accessibility requirements in their designs, but without detailed guidance on the specific behavior of the interface, developers may miss key aspects.

Even when accessibility features are implemented, the flow of the interface may not be optimized for assistive technology users. For example, while all interactive elements may be included in the correct focus order, inefficient navigation, such as having to tab through an entire header to reach a main content button, can create a frustrating user experience. This leads to abandonment by users and ultimately harms both business outcomes and brand reputation by not providing an inclusive and efficient experience.

It would therefore be advantageous to provide a solution that addresses the above challenges.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that, in operation, causes or cause the system to perform the actions. One or more computer programs can be configured to perform particular operations or actions by virtue of including instructions that, when executed by a data processing apparatus, cause the apparatus to perform the actions.

In one general aspect, the method may include receiving a prototype of a design of a digital interface and underlying data structures of the design, where a prototype is an interactive, visual representation of plurality of layouts of a digital interface that simulates an user experience of navigating between the plurality of layouts; annotating each graphical user interface (GUI) element of the prototype with a label that provides sufficient detail to identify the purpose of the GUI element based on the received prototype and the received underlying data structures; verifying that an user flow is executable on the prototype, where an user flow is a navigation path by an accessibility technology user through the plurality of layouts of the prototype; generating a score for the prototype based on a level of accessibility of the prototype for the user flow for a particular accessibility technology user; implementing improvements in the prototype, where implementing improvements serve to increase the score for the user flow in the prototype. Other embodiments of this aspect include corresponding computer systems, apparatus, and computer programs recorded on one or more computer storage devices, each configured to perform the actions of the methods.

Implementations may include one or more of the following features. The method may include: generating a graphical representation of the prototype, where nodes represent the annotated GUI elements and edges represent possible interactions connecting those nodes; generating a prompt configured to be executed by a Large Language Model (LLM), where the prompt is based on the user flow and the graphical representation of the prototype; executing, by the LLM, the prompt to verify whether the user flow is executable on the prototype.

The method may include: when the user flow is verified as executable on the prototype, determining, by the LLM, a set of nodes and edges in the graphical representation that represent the user flow within the prototype.

The method where generating a score for the user flow in the prototype further may include: computing, based on the annotated GUI elements of the design, the shortest navigational path between steps in the user flow of the prototype.

The method where implementing improvements in the prototype further may include: modifying the prototype to shorten the computed shortest navigational path between steps in the user flow of the prototype.

The method where modifying the prototype to shorten the shortest navigational path between steps in the user flow of the prototype further may include: utilizing an LLM to provide specific recommendations to shorten the navigational paths between steps in the user flow of the prototype.

The method may include: identifying, using a multi-modal computer vision AI model trained on digital interfaces, each GUI element of the prototype.

The method may include: generating a prompt configured to be executed by an LLM, where the prompt is based on an object representation of the prototype; executing the LLM to classify the functional pattern of each GUI element of the prototype.

The method may include: generating a score for the user flow that measures usability of the prototype for users.

The method where implementing improvements in the prototype further may include: modifying the prototype to increase the usability of the user flow of the prototype.

The method may include: annotating an image of the prototype of the design with a text alternative for the image. Implementations of the described techniques may include hardware, a method or process, or a computer tangible medium.

In one general aspect, a non-transitory computer-readable medium may include one or more instructions that, when executed by one or more processing circuitries of a device, cause the device to: receive a prototype of a design of a digital interface and underlying data structures of the design, where a prototype is an interactive, visual representation of plurality of layouts of a digital interface that simulates an user experience of navigating between the plurality of layouts; annotate each graphical user interface (GUI) element of the prototype with a label that provides sufficient detail to identify the purpose of the GUI element based on the received prototype and the received underlying data structures; verify that an user flow is executable on the prototype, where an user flow is a navigation path by an accessibility technology user through the plurality of layouts of the prototype; generate a score for the prototype based on a level of accessibility of the prototype for the user flow for a particular accessibility technology user; and implement improvements in the prototype, where implementing improvements serve to increase the score for the user flow in the prototype. Other embodiments of this aspect include corresponding computer systems, apparatus, and computer programs recorded on one or more computer storage devices, each configured to perform the actions of the methods.

In one general aspect, the system may include a processing circuitry. The system may also include a memory, the memory containing instructions that, when executed by the processing circuitry, configure the system to: receive a prototype of a design of a digital interface and underlying data structures of the design, where a prototype is an interactive, visual representation of plurality of layouts of a digital interface that simulates an user experience of navigating between the plurality of layouts; annotate each graphical user interface (GUI) element of the prototype with a label that provides sufficient detail to identify the purpose of the GUI element based on the received prototype and the received underlying data structures; verify that an user flow is executable on the prototype, where an user flow is a navigation path by an accessibility technology user through the plurality of layouts of the prototype; generate a score for the prototype based on a level of accessibility of the prototype for the user flow for a particular accessibility technology user; implement improvements in the prototype, where implementing improvements serve to increase the score for the user flow in the prototype. Other embodiments of this aspect include corresponding computer systems, apparatus, and computer programs recorded on one or more computer storage devices, each configured to perform the actions of the methods.

Implementations may include one or more of the following features. The system where the memory contains further instructions which when executed by the processing circuitry further configure the system to: generate a graphical representation of the prototype, where nodes represent the annotated GUI elements and edges represent possible interactions connecting those nodes; generate a prompt configured to be executed by a Large Language Model (LLM), where the prompt is based on the user flow and the graphical representation of the prototype; and execute, by the LLM, the prompt to verify whether the user flow is executable on the prototype.

The system where the memory contains further instructions which when executed by the processing circuitry further configure the system to: when the user flow is verified as executable on the prototype, determine, by the LLM, a set of nodes and edges in the graphical representation that represent the user flow within the prototype.

The system where the memory contains further instructions that, when executed by the processing circuitry for generating a score for the user flow in the prototype, further configure the system to: compute, based on the annotated GUI elements of the design, the shortest navigational path between steps in the user flow of the prototype.

The system where the memory contains further instructions that, when executed by the processing circuitry for implementing improvements in the prototype, further configure the system to: modify the prototype to shorten the computed shortest navigational path between steps in the user flow of the prototype.

The system where the memory contains further instructions that, when executed by the processing circuitry for modifying the prototype to shorten the shortest navigational path between steps in the user flow of the prototype, further configure the system to: utilize an LLM to provide specific recommendations to shorten the navigational paths between steps in the user flow of the prototype.

The system where the memory contains further instructions which when executed by the processing circuitry further configure the system to: identify, using a multi-modal computer vision AI model trained on digital interfaces, each GUI element of the prototype.

The system where the memory contains further instructions which when executed by the processing circuitry further configure the system to: generate a prompt configured to be executed by an LLM, where the prompt is based on an object representation of the prototype; and execute the LLM to classify the functional pattern of each GUI element of the prototype.

The system where the memory contains further instructions which when executed by the processing circuitry further configure the system to: generate a score for the user flow that measures usability of the prototype for users.

The system where the memory contains further instructions that, when executed by the processing circuitry for implementing improvements in the prototype, further configure the system to: modify the prototype to increase the usability of the user flow of the prototype.

The system where the memory contains further instructions, which when executed by the processing circuitry, further configure the system to: annotate an image of the prototype of the design with a text alternative for the image. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows an example network diagram utilized to describe the various disclosed embodiments.

FIG. 2 is a flowchart of an example process for identification and labelling of elements of digital design according to an embodiment.

FIG. 3 is a flowchart of an example process for analyzing the navigability and usability of user flows with the design of a digital interface according to an embodiment.

FIG. 4 is an example interface that illustrates a checklist for identification and annotation of elements of a design according to an embodiment.

FIG. 5 is an example prototype sample that illustrates an analysis of user flows in a prototype according to an embodiment.

FIG. 6 is an example diagram illustrating an operation to resolve a meaningless names issue according to an embodiment.

FIG. 7 is an example diagram illustrating the operation of a prototype user flow analyzer according to an embodiment.

FIG. 8 is an example diagram illustrating the operation of a prototype user flow analyzer according to an embodiment.

FIG. 9 is an example schematic diagram of a design assistance system according to an embodiment.

### DETAILED DESCRIPTION

It is important to note that the embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The disclosed embodiments include identification capabilities while analyzing layouts (or parts of them) and design prototypes with artificial intelligence (AI) algorithms (discussed in more detail below). These capabilities of the disclosed embodiments allow for identifying interactive and structural elements (such as landmarks and headings) by evaluating not only visual aspects but also the underlying JavaScript Object Notation (JSON) structure of designs. Elements may be construed as fundamental building blocks of a web page, web application, or mobile application (the disclosed embodiments apply to all forms of digital interfaces on web and mobile). Analyzing the underlying JSON allows for streamlining workflows by eliminating the need for any manual annotation, therefore saving individuals and organizations vast amount of time. The disclosed embodiments also includes the addition of meaningful labels for elements of a design and alternative text for elements that require such alternative text.

Additionally, the various disclosed embodiments include the analysis of prototypes to help designers improve the flow of designs of digital interfaces for assistive technology users. A prototype is an interactive, visual representation, composed of multiple layouts of a website or application, before development begins, that simulates the user experience of navigating between the layouts. The analysis, according to various disclosed embodiments, includes identifying issues in the design flow that otherwise cannot be identified by analyzing static layouts of a website or application and provides suggestions on how to solve such issues.

The identification of elements of a design (e.g., landmarks, headings, interactive elements, images, etc.) includes adding labels for each element as well as roles of each interactive element (e.g., the role of a button). This identification and labelling enables the design of web pages and mobile applications to meet accessibility requirements (e.g., focus and reading order may be inferred based on the labels).

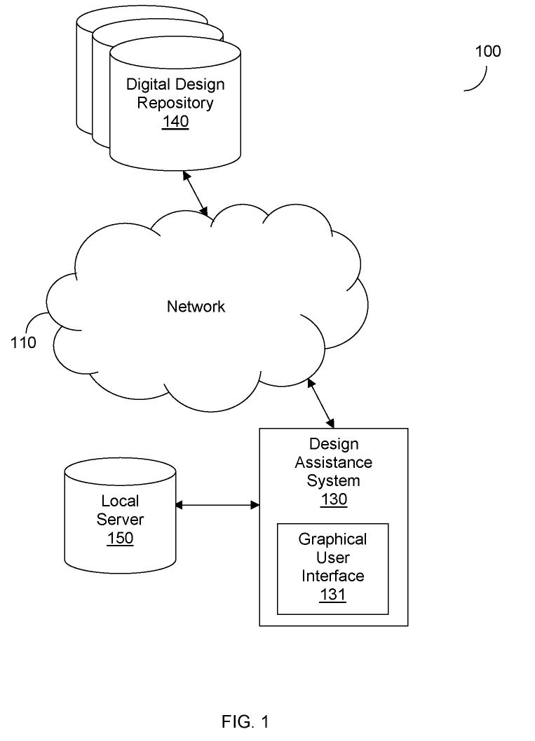

FIG. 1 shows an example network diagram 100 utilized to describe the various disclosed embodiments. In the example, a network diagram 100, a digital design repository 140, a design assistance system 130, and a local server 150 communicate via a network 110. The network 110 may be, but is not limited to, a wireless, cellular or wired network, a local area network (LAN), a wide area network (WAN), a metro area network (MAN), the Internet, the world wide web (WWW), similar networks, and any combination thereof.

The digital design repository 140 stores digital resources including, but not limited to, web page software and mobile applications software. In an embodiment, the software is of web pages and mobile applications that are currently undergoing design development. The design assistance system 130 may, over the network 110, retrieve web pages and mobile applications software from the digital design repository 140. A graphical user interface (GUI) 131 of a web page or mobile application is retrieved by the design assistance system 130. According to various embodiments, the GUI 131 should be construed as including prototypes and layouts (defined above) of web pages and mobile applications displayed through the GUI 131.

In an embodiment, the design assistance system 130 executes, in part, on the GUI 131. The operating system (OS) on which the web page or mobile application is hosted and on which the GUI 131 is displayed has enabled accessibility technology of the native operating system of the mobile application e.g., VoiceOver® on iOS®.

The structure of a GUI 131 includes components. A component is a discrete, interactive element that users engage with to perform an action or view information such as, but not limited to, a button (to trigger an action or event within the interface), a toggle (to switch between two states or options), a radio button (to select one option from a group of mutually exclusive choices), a text field (to input data, like typing text or entering values), a header (to define the title or category of a section), a combobox (to choose from a list of options), a checkbox (to select one or more options from a list), a slider (to adjust a value within a defined range), a progress bar (to indicate the completion status of a process or task), a modal window (to present additional content or actions in a temporary overlay), and a tooltip (to offer brief, contextual information about an element when users hover or focus on the element).

In an alternative embodiment, the design assistance system 130 may retrieve web page software and mobile application software from a local server 150. According to this embodiment, the local server 150 may include the code (written in a variety of programming languages depending on the operating system deployment of the web page or the mobile application). In another embodiment, results of the operations of the design assistance system 130 may be saved and stored on the local server 150.

The design assistance system 130 can be realized in software, hardware, firmware, or combination thereof. The software comprises one or more computer-readable storage media storing instructions that, when executed by one or more processors, cause the system to perform one or more functions as described herein. The software may be implemented in various programming languages and may operate on different computing environments, including but not limited to cloud-based systems, distributed networks, standalone computing devices, or embedded systems. The software may include algorithms, machine learning models, or rule-based processing to achieve the described functionality. Various implementations may employ modular, service-oriented, or microservices architectures, and the system may interface with databases, APIs, or external services.

In an embodiment, the design assistance system 130 is executed by a generative AI (genAI) system integrated into design assistance system 130. In one embodiment, the genAI system may be located outside of design assistance system 130 and could be operated by a remote server (not shown).

In some embodiments, the identification capabilities (discussed above) may be performed using computer vision, a multi-modal model (both trained on web pages and adapted to work for designs). In an alternative embodiment, an object representation of the design may be used with a specialized Large Language Model (LLM) prompt to classify the functional pattern of each element of the design and provide a name for each element of the design. The functional pattern of a UI element refers to how the element actually behaves.

Although FIG. 1 shows example elements of the network diagram 100, in some implementations, the network diagram 100 may include additional elements, fewer elements, different elements, or differently arranged elements than those depicted in FIG. 1.

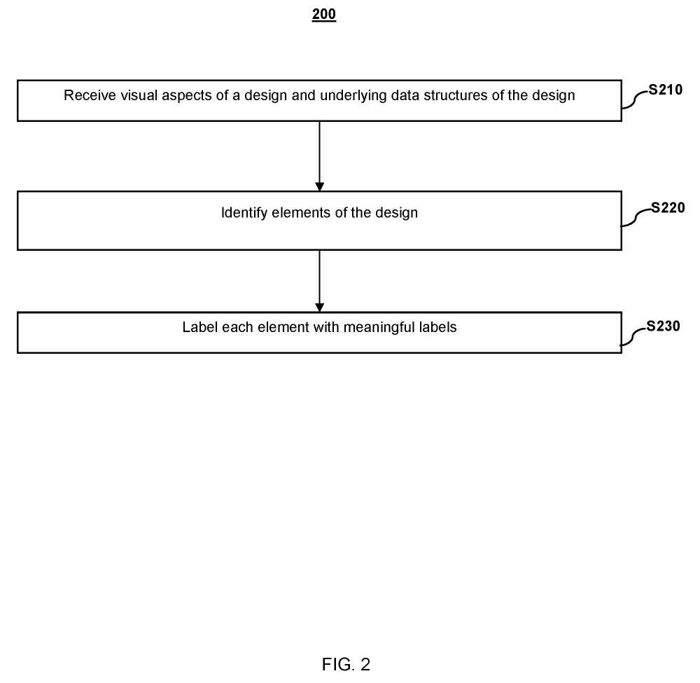

FIG. 2 is a flowchart of an example process 200 for identification and labelling of elements of digital design according to an embodiment. In some implementations, one or more process blocks of FIG. 2 may be performed by design assistance system 130.

At S210, visual aspects of a design and underlying data structures of the design are received. Visual aspects of the design may include elements of the design (defined above). The underlying data structures may include JSON that corresponds to the visual aspects of the design.

In an embodiment, the visual aspects of the design may include prototypes of the design (including layouts) as defined above.

At S220, elements of the design are identified. In an embodiment, interactive elements, structural elements, and images are all identified based on the received visual aspects and underlying data structures of the design.

In an embodiment, a designer may edit the element type that is identified or manually add or subtract different elements.

At S230, each element is annotated with a meaningful label (hereinafter, meaningful label, meaningful name, or the like). A meaningful label is defined as a label that provides sufficient detail to identify the purpose of an element. For example, a button that says “Book an appointment,” that is labelled as “rectangle8,” does not have a meaningful label. A button that says “Book an appointment,” that is labelled as “button,” or “appointment button,” may contain sufficient detail to be considered a meaningful label.

In an embodiment, annotating an interactive element may include labelling that element with a role. A role is defined as the purpose of the interactive element (e.g., the role of a button is for the user to click it to perform a given operation). In an alternative embodiment, annotating an image may include providing alternative text for that image.

In an embodiment, a designer may change the annotation given to an element.

Annotating identified elements according to the disclosed embodiments enables a designer to hand over the design to a developer with guidelines that include the identified elements and annotations associated with those identified elements.

Although FIG. 2 shows example blocks of process 200, in some implementations, process 200 may include additional blocks, fewer blocks, different blocks, or differently arranged blocks than those depicted in FIG. 2. Additionally, or alternatively, two or more of the blocks of process 200 may be performed in parallel.

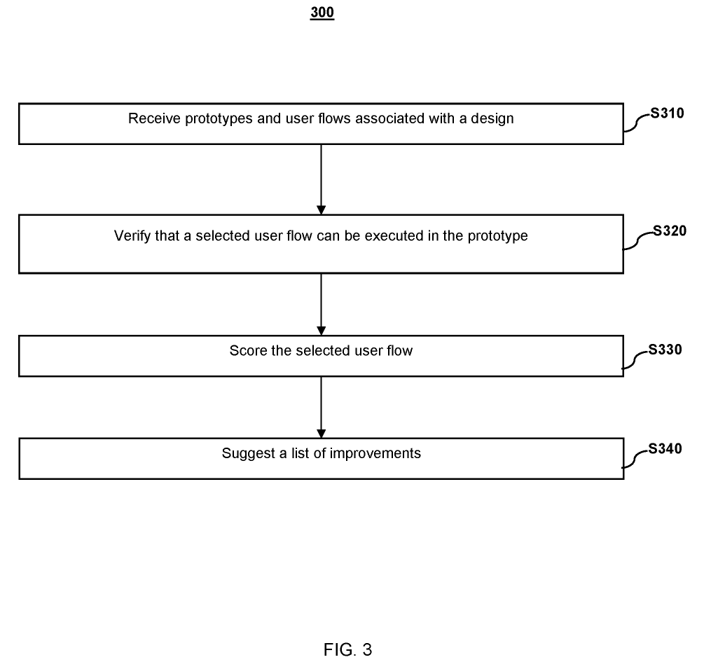

FIG. 3 is a flowchart of an example process 300 for analyzing the navigability and usability of user flows with the design of a digital interface according to an embodiment. In some implementations, one or more process blocks of FIG. 3 may be performed by design assistance system 130.

At S310, prototypes and user flows are received. Prototypes, as defined above, are interactive, visual representations, composed of multiple layouts of a web page or application, before development begins, that simulates the user experience of navigating between the layouts. A user flow is a navigation path of an accessibility technology user through the layouts of the prototype.

At S320, it is verified that a selected user flow can be executed in the prototype. As an example, a selected user flow may include adding an item to a cart and navigating to a checkout page to buy that item. If this selected user flow is matched with a prototype that includes a layout for a shopping page (including a button that allows a user to add an item to cart) and a layout for a checkout page (including a buy button and any other necessary elements), then it is verified that this selected user flow is executable in the prototype.

In an embodiment, verifying that the user flow can be executed on the prototype involves generating a graph representation of the prototype where the nodes are represented by the roles and names identified (according to the embodiments disclosed with respect to FIG. 2) and the edges are the possible interactions connecting those nodes. In an embodiment, this graph representation along with the user flow is provided in a custom LLM prompt configured to be executed by an LLM which identifies whether the user flow can be performed on the prototype and, if so, which set of nodes and edges represent the user flow within the prototype.

At S330, the prototype for the user flow is scored. In an embodiment, a score may be generated for different types of accessibility users (e.g., screen reader user, keyboard user, and low vision user). In one embodiment, the score is generated based on how accessible the prototype is for the particular user flow used by a particular type of user. In another embodiment, the score may include a measure based on the usability of the prototype (even if the prototype does not violate accessibility standards or guidelines). Usability refers to the degree to which the navigability of the prototype is logical, convenient, efficient, a combination thereof, and the like. The score may be numerical, categorical, a combination thereof, and the like.

In an embodiment, the scoring of user flows involves using the annotated elements generated with respect to FIG. 2 to calculate the shortest navigational path between steps in the prototype for screen reader users, keyboard users, and low vision users.

At S340, a list of improvements are suggested. In an embodiment, suggested improvements may be related to one or more layouts of the prototype, the entire prototype, and the navigability between layouts in the prototype, but is not limited to such categories of improvements. Improvements are suggested changes to the elements of the prototype that serve to increase the score of various user flows in the prototype. The improvements may also include suggestions to change the elements of the prototype to increase the usability of the user flow in the prototype (e.g., for a screen reader user, add a skip link on a particular layout).

In an embodiment, the calculated shortest navigational paths between steps in the prototype used for scoring user flows is used to suggest improvements e.g., taking the shortest navigational path to an element. Algorithms (including rules, LLMs or other models) may be used to provide specific recommendations for how to shorten those paths, as well as identify accessibility issues. For example, screen readers allow users to navigate quickly through predefined types of elements such as headings, landmarks, links and form controls (e.g., through Rotor on Apple®’s VoiceOver®). In many cases, adding relevant landmarks or headings can significantly shorten the path of a screen reader user to a given element.

In an embodiment, the suggested improvements may be implemented in the prototype. In another embodiment, a designer may review the suggestions and select which to implement. The designer may re-test the improved user flow on the prototype to see an updated score. In an embodiment, the designer can generate user guidelines for the correct implementation of the prototype.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

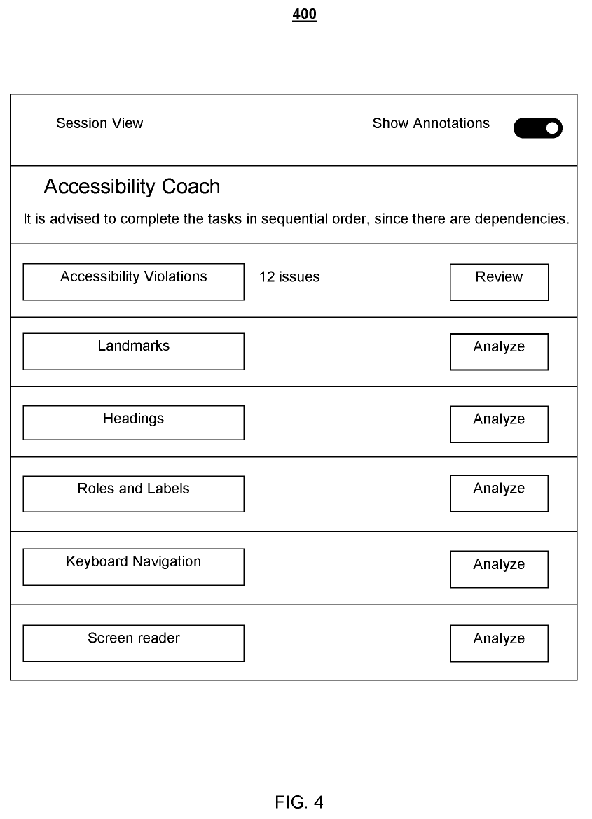

FIG. 4 is an example interface 400 that illustrates a checklist for identification and annotation of elements of a design according to an embodiment. The identification and annotation of elements is discussed in more detail with respect to FIG. 2.

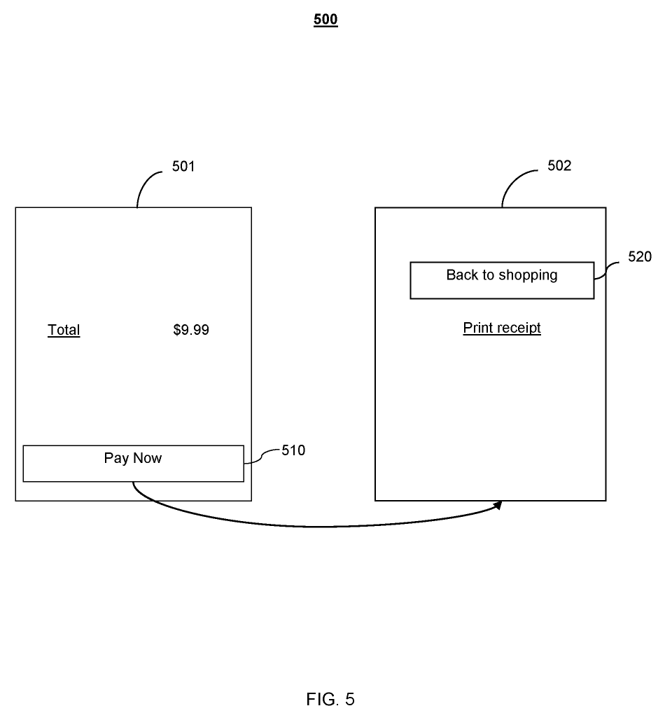

FIG. 5 is an example prototype sample 500 that illustrates an analysis of user flows in a prototype according to an embodiment. Analyzing the navigability and usability of user flows with the design of a digital interface is discussed in more detail with respect to FIG. 3.

Product page layout 501 depicts an interactive “pay now” button 510 associated with the product. The prototype sample 500 illustrates an arrow that shows a user navigation between product page layout 501 and cart page layout 502 via clicking “pay now” button 510. When a user selects the “pay now” button 510, the prototype sample 500 shows that the user navigation will move to a cart page layout 502 including a cart (not shown) in which the user has added the product (not shown) depicted on the product page layout 501. The cart page layout 502 includes a “back to shopping” button 520 that shows a connection (a user navigation) between the cart page layout 502 and a shopping page layout (not shown).

In some embodiments, relationship graph (not shown) is generated based on a prototype. In some embodiments, the relationship graph includes the interactable UI elements as nodes (including the names of such interactable UI elements) and navigation relationships between the interactable UI elements as edges (including a type of user interaction that triggers navigation to related nodes).

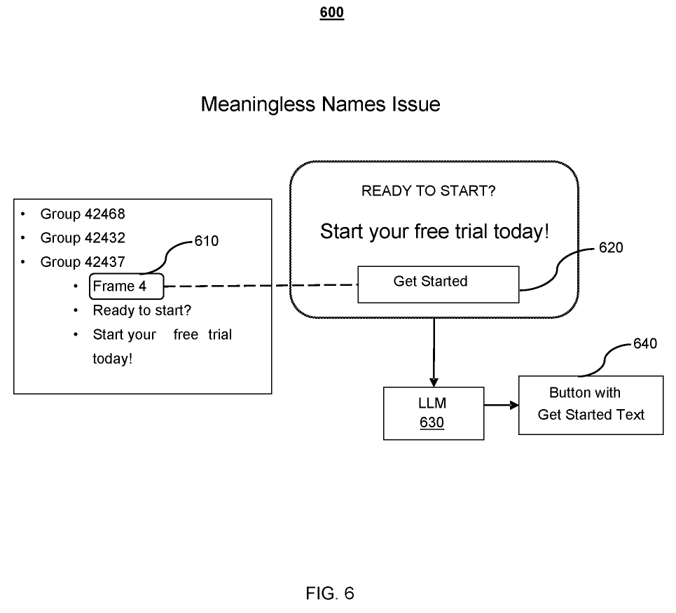

FIG. 6 is an example diagram 600 illustrating an operation to resolve a meaningless names issue according to an embodiment.

Meaningless name 610 is called “frame 4” and corresponds to button 620 in a prototype. In some embodiments, a prompt configured to be fed to LLM 630 is generated. The generated prompt includes a snapshot of the button 620 and an instruction to provide candidate name 640 for the button 620 that are meaningful. As explained above, a meaningful name is defined as a name that provides sufficient detail to identify the purpose of an UI element. In some embodiments, a name is meaningful when the name exceeds a predetermined threshold meaningfulness value. For example, a name exceeds a predetermined threshold meaningfulness value when the name is referential to attributes of the UI element in the prototype. Based on the prompt fed to the LLM 630, LLM 630 is configured to output name 640. For example, candidate name 640 may be “button with get started text.” Name 640 is configured to replace name 610.

In some embodiments, LLM 630 may be part of design assistance system 130. Additionally, LLM 630 may be a multi-modal model (both trained on web pages and adapted to work for designs). In an alternative embodiment, an object representation of the design may be used with a specialized Large Language Model (LLM) prompt to classify the functional pattern of each element of the design and provide a name for each element of the design.

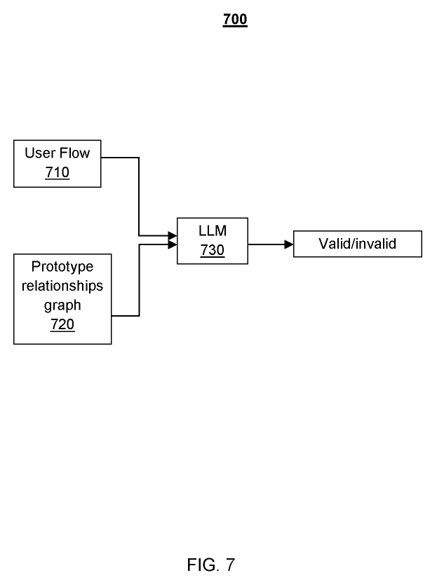

FIG. 7 is an example diagram 700 illustrating the operation of a prototype user flow analyzer according to an embodiment.

User flow 710 and prototype relationships graph 720 are included in a prompt fed to LLM 730. User flow 710 is a navigation path by an accessibility technology user. It should be noted that prototype relationships graph includes nodes of UI elements (with UI elements given meaningful names as discussed herein) and edges of navigation relationships between those UI elements of the prototype. LLM 730 is configured to output a response on whether the user flow 710 is sufficiently aligned with the prototype relationships graph 720 (shown as valid/invalid output of the LLM 730). Sufficiently aligned refers to whether the user flow 710 is executable on the prototype.

In some embodiments, based on the output of the LLM 730, the prototype is analyzed to identify accessibility issues, with a focus on two key aspects related to at least Screen Reader Flow and Keyboard Navigation. The screen reader flow ensures that the experience is intuitive and navigable for users relying on screen readers. The keyboard navigation verifies that efficient navigation through the interface is possible using only a keyboard. These flows are then optimized, as compliance with screen reader requirements does not necessarily guarantee a seamless or efficient user experience. By refining these interactions, accessibility is enhanced to provide a more intuitive and user-friendly experience

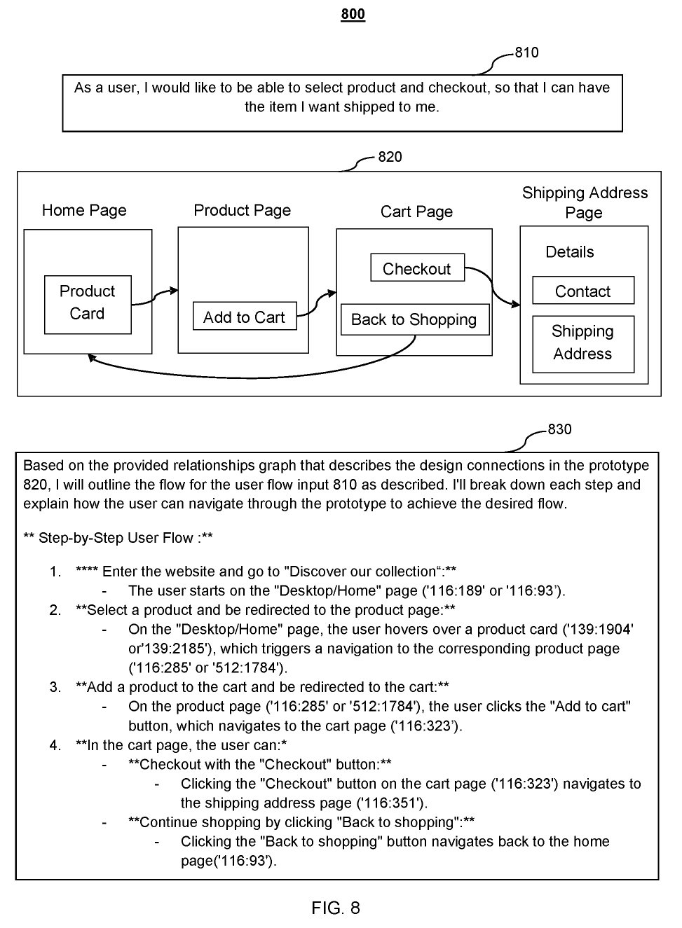

FIG. 8 is an example diagram 800 that illustrates the operation of a prototype user flow analyzer according to an embodiment.

User flow input 810 is an example natural language input of a user, tester, or the like that conveys a navigation path and a desired outcome on a website (not shown). Prototype 820 depicts UI elements of various web pages of a website and navigation relationships between the UI elements. Prototype 820 shows the relevant UI elements and connections for the user flow input 810.

In some embodiments, user flow input 810 and prototype 820 are included in a prompt configured to be executed by an LLM (not shown). LLM is also configured to receive a relationships graph (not shown) for the prototype 820. The output of the LLM is depicted as LLM output 830. LLM output 830 is configured to generate a natural language description of a user flow in the prototype 820 based on the relationships graph and the user flow input 810. LLM outputs 830 includes references to bounding box coordinates (not shown) of the relationships graph and a step-by-step navigation path (user flow) for the user to achieve the desired outcome on the website.

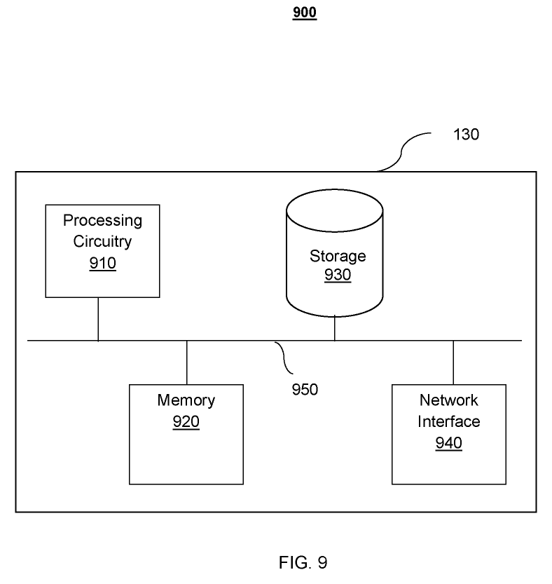

FIG. 9 is an example schematic diagram 900 of a design assistance system 130 according to an embodiment. The design assistance system 130 includes a processing circuitry 910 coupled to a memory 920, a storage 930, and a network interface 940. In an embodiment, the components of the design assistance system 130 may be communicatively connected via a bus 950.

In an embodiment, the processing circuitry 910 is configured to execute generative artificial intelligence (genAI) models, perform inference using or otherwise apply genAI models, train genAI models, fine-tune genAI models, combinations thereof, and the like. Such genAI models are configured to produce text, images, videos, or other forms of data, and may include, but are not limited to, language models (for example, but not limited to, large language models, small language models, etc.), text-to-image artificial intelligence (AI) image generation systems, text-to-video AI video generators, combinations thereof, and the like. To this end, the processing circuitry 910 may be adapted to realize a transformer deep learning architecture (e.g., a generative pre-trained transformer [GPT], bidirectional encoder representations from transformers [BERT], text-to-text transfer transformer [T5], etc.), a diffusion model, both, and the like.

In accordance with various such embodiments, the hardware utilized for the processing circuitry 910 is selected in order to enable genAI functionality based on factors such as, but not limited to, parallelism (e.g., amounts of parallel processing to be performed), memory demands (e.g., amounts of random access memory [RAM] utilized to store model weights and training during processing or video RAM [VRAM] to support large language models), clock speeds, thread counts, storage (for example, to support certain amounts of storage or storage speeds), cooling (e.g., liquid cooling or air cooling systems), power supply (e.g., in order to enable a target wattage used for certain kinds of activities), networking and connectivity (e.g., in order to support seamless data transfer for deployments involving communications between or among multiple machines or clusters), combinations thereof, and the like.

In embodiments which utilize large language models (LLMs) or otherwise perform operations which may require or be enhanced through use of parallel processing, the processing circuitry 910 may include one or more GPUs or other processing units suitable for parallel processing. Such GPUs may be configured to perform matrix multiplication operations including, but not limited to, performing dot product operations in order to support neural network operations (for example, by performing dot product operations for hidden layer computations) or performing dot product operations in an attention mechanism in order to compute a similarity score between vectors during attention weight computation. In at least some such embodiments using GPUs, the processing circuitry 910 may include a number of CPU cores which is equal to or greater than the number of GPUs in order to facilitate or otherwise support parallel processing via multiple GPUs.

The processing circuitry 910 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 920 may be volatile (e.g., random access memory, etc.), non-volatile (e.g., read only memory, flash memory, etc.), or a combination thereof.

In one configuration, software for implementing one or more embodiments disclosed herein may be stored in the storage 930. In another configuration, the memory 920 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 910, cause the processing circuitry 910 to perform the various processes described herein.

In some embodiments, the storage 930 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 940 allows the design assistance system 130 to communicate with, for example, the digital design repository 140, and the like.

It should be understood that the embodiments described herein are not limited to the specific architecture illustrated in FIG. 9, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like

What is claimed is:

1. A method for improving navigability of digital interfaces for accessibility technology users comprising:
receiving a prototype of a design of a digital interface and underlying data structures of the design, wherein a prototype is an interactive, visual representation of plurality of layouts of a digital interface that simulates a user experience of navigating between the plurality of layouts;
annotating each graphical user interface (GUI) element of the prototype with a label that provides sufficient detail to identify the purpose of the GUI element based on the received prototype and the received underlying data structures;
verifying that a user flow is executable on the prototype, wherein a user flow is a navigation path by an accessibility technology user through the plurality of layouts of the prototype;
generating a score for the prototype based on a level of accessibility of the prototype for the user flow for a particular accessibility technology user; and
implementing improvements in the prototype, wherein implementing improvements serve to increase the score for the user flow in the prototype.

2. The method of claim 1, further comprising:
generating a graphical representation of the prototype, where nodes represent the annotated GUI elements and edges represent possible interactions connecting those nodes;
generating a prompt configured to be executed by a Large Language Model (LLM), wherein the prompt is based on the user flow and the graphical representation of the prototype;
executing, by the LLM, the prompt to verify whether the user flow is executable on the prototype.

3. The method of claim 2, further comprising:
when the user flow is verified as executable on the prototype, determining, by the LLM, a set of nodes and edges in the graphical representation that represent the user flow within the prototype.

4. The method of claim 1, wherein generating a score for the user flow in the prototype further comprises:
computing, based on the annotated GUI elements of the design, the shortest navigational path between steps in the user flow of the prototype.

5. The method of claim 4, wherein implementing improvements in the prototype further comprises:
modifying the prototype to shorten the computed shortest navigational path between steps in the user flow of the prototype.

6. The method of claim 5, wherein modifying the prototype to shorten the shortest navigational path between steps in the user flow of the prototype further comprises:
utilizing an LLM to provide specific recommendations to shorten the navigational paths between steps in the user flow of the prototype.

7. The method of claim 1, further comprising:
identifying, using a multi-modal computer vision AI model trained on digital interfaces, each GUI element of the prototype.

8. The method of claim 1, further comprising:
generating a prompt configured to be executed by an LLM, wherein the prompt is based on an object representation of the prototype;
executing the LLM to classify the functional pattern of each GUI element of the prototype.

9. The method of claim 1, further comprising:
generating a score for the user flow that measures usability of the prototype for users.

10. The method of claim 9, wherein implementing improvements in the prototype further comprises:
modifying the prototype to increase the usability of the user flow of the prototype.

11. The method of claim 1, further comprising:
annotating an image of the prototype of the design with a text alternative for the image.

12. A non-transitory computer-readable medium storing a set of instructions for improving navigability of digital interfaces for accessibility technology users, the set of instructions comprising:
one or more instructions that, when executed by one or more processing circuitries of a device, cause the device to:
receive a prototype of a design of a digital interface and underlying data structures of the design, wherein a prototype is an interactive, visual representation of plurality of layouts of a digital interface that simulates a user experience of navigating between the plurality of layouts;
annotate each graphical user interface (GUI) element of the prototype with a label that provides sufficient detail to identify the purpose of the GUI element based on the received prototype and the received underlying data structures;
verify that a user flow is executable on the prototype, wherein a user flow is a navigation path by an accessibility technology user through the plurality of layouts of the prototype;
generate a score for the prototype based on a level of accessibility of the prototype for the user flow for a particular accessibility technology user; and
implement improvements in the prototype, wherein implementing improvements serve to increase the score for the user flow in the prototype.

13. A system for improving navigability of digital interfaces for accessibility technology users comprising:
a processing circuitry;
a memory, the memory containing instructions that, when executed by the processing circuitry, configure the system to:
receive a prototype of a design of a digital interface and underlying data structures of the design, wherein a prototype is an interactive, visual representation of plurality of layouts of a digital interface that simulates a user experience of navigating between the plurality of layouts;
annotate each graphical user interface (GUI) element of the prototype with a label that provides sufficient detail to identify the purpose of the GUI element based on the received prototype and the received underlying data structures;
verify that a user flow is executable on the prototype, wherein a user flow is a navigation path by an accessibility technology user through the plurality of layouts of the prototype;
generate a score for the prototype based on a level of accessibility of the prototype for the user flow for a particular accessibility technology user; and
implement improvements in the prototype, wherein implementing improvements serve to increase the score for the user flow in the prototype.

14. The system of claim 13, wherein the memory contains further instructions which when executed by the processing circuitry further configure the system to:
generate a graphical representation of the prototype, where nodes represent the annotated GUI elements and edges represent possible interactions connecting those nodes;
generate a prompt configured to be executed by a Large Language Model (LLM), wherein the prompt is based on the user flow and the graphical representation of the prototype; and
execute, by the LLM, the prompt to verify whether the user flow is executable on the prototype.

15. The system of claim 14, wherein the memory contains further instructions which when executed by the processing circuitry further configure the system to:
when the user flow is verified as executable on the prototype, determine, by the LLM, a set of nodes and edges in the graphical representation that represent the user flow within the prototype.

16. The system of claim 13, wherein the memory contains further instructions that, when executed by the processing circuitry for generating a score for the user flow in the prototype, further configure the system to:
compute, based on the annotated GUI elements of the design, the shortest navigational path between steps in the user flow of the prototype.

17. The system of claim 16, wherein the memory contains further instructions that, when executed by the processing circuitry for implementing improvements in the prototype, further configure the system to:
modify the prototype to shorten the computed shortest navigational path between steps in the user flow of the prototype.

18. The system of claim 17, wherein the memory contains further instructions that, when executed by the processing circuitry for modifying the prototype to shorten the shortest navigational path between steps in the user flow of the prototype, further configure the system to:
utilize an LLM to provide specific recommendations to shorten the navigational paths between steps in the user flow of the prototype.

19. The system of claim 13, wherein the memory contains further instructions which when executed by the processing circuitry further configure the system to:
identify, using a multi-modal computer vision AI model trained on digital interfaces, each GUI element of the prototype.

20. The system of claim 13, wherein the memory contains further instructions which when executed by the processing circuitry further configure the system to:
generate a prompt configured to be executed by an LLM, wherein the prompt is based on an object representation of the prototype; and
execute the LLM to classify the functional pattern of each GUI element of the prototype.

21. The system of claim 13, wherein the memory contains further instructions which when executed by the processing circuitry further configure the system to:
generate a score for the user flow that measures usability of the prototype for users.

22. The system of claim 21, wherein the memory contains further instructions that, when executed by the processing circuitry for implementing improvements in the prototype, further configure the system to:
modify the prototype to increase the usability of the user flow of the prototype.

23. The system of claim 13, wherein the memory contains further instructions which when executed by the processing circuitry further configure the system to:
annotate an image of the prototype of the design with a text alternative for the image.
